(19) United States
(12) Patent Application Publication
(10) Pub. No.: US 2024/0157258 A1
(43) Pub. Date: May 16, 2024

(54) Position-Adjustable Connector for Mobile Device Controller

(71) Applicant: Backbone Labs, Inc., Vancouver, WA (US)

(72) Inventors: Ozhan Maker, San Diego, CA (US); Zachary Scott, Palo Alto, CA (US); Eric Sorensen, Portland, OR (US); Cory Newton, Palo Alto, CA (US)

(73) Assignee: Backbone Labs, Inc., Vancouver, WA (US)

(21) Appl. No.: 18/389,063

(22) Filed: Nov. 13, 2023

Related U.S. Application Data
(60) Provisional application No. 63/425,655, filed on Nov. 15, 2022.

(51) Int. Cl. A63F 13/98

(52) U.S. Cl. CPC A63F 13/98

(57) ABSTRACT

A gaming device that includes a handheld controller with a handle and a mechanism for connecting the handheld controller to a mobile device. The mechanism includes a substantially rigid arm and a connector. The arm is housed within the handle and is configured to pivot about a pivot point within the handle. The connector is attached to the arm at the end opposite the pivot point and is structured to physically and electrically pair the mobile device and the handheld controller. The connector is structured to pivot about the pivot point with the arm.

### TECHNICAL FIELD

The subject matter is related to an apparatus and methods for connecting a mobile device to a gaming device, and, more particularly, to a system and methods for adjusting the height of a connector on a gaming device to accommodate mobile devices of varying dimensions.

### BACKGROUND

The gaming world has recently seen handheld devices entering the market that interface with mobile devices, simulating the traditional console experience while playing on a mobile device. These handheld devices typically consist of two handles—mimicking the grip, button, and joystick configurations of traditional console controllers—and some mode of connecting the device through a mobile device's primary input port (e.g., lightning, USB-C, etc.). When the device is connected, a user can either run games locally on their mobile device or participate in cloud gaming and utilize the console-like controller for providing input, as opposed to the mobile device's own touchscreen or buttons.

The current devices on the market use connectors that are fixed in a position somewhere on the device, typically on the inner edge of one of the handles, and cannot be moved in any direction. Accordingly, a user must maneuver their mobile device and guide the input port to the location of the connector on the device and insert the connector. Although this process may appear simple, the wide variety of mobile device dimensions and protective cases can make inserting a completely stationary connector difficult. A mobile device with a length equal to or slightly longer than the maximum width of the gaming device, for example, may not fit within the device when considering the additional clearance needed to insert the connector. Or, alternatively, a mobile device with a particularly thick protective case may sit higher than the plane for inserting the connector.

Because the connectors on current market devices resist motion in any direction, attempts to overcome dimension difficulties while inserting a mobile device could lead to damage to either the connector or the input port on the mobile device itself. For instance, a user trying to overcome a thick protective case causing the mobile device to sit too high above the connector may try to force the connector into the input port, leading the connector to bend or break within the port.

Devices with comparable connectors, such as docking stations for mobile devices, have implemented flexible connectors that rotate about a hinge and change the approach angle. These flexible connectors allow a user to insert or remove a mobile device at an angle for easier access, but ultimately the connectors return to a single, default resting position on the docking station. Changing the approach angle does not fulfill the need described for mobile gaming devices. In fact, it is detrimental. Mobile devices must remain substantially flat on a gaming device for practical use, so the problems associated with varying dimensions and protective case sizes require the resting position to be adjustable, not the approach angle. Consequently, a device is needed that accommodates mobile device dimensions and protective cases over a wide range and limits the potential for damage while inserting a mobile device for game play.

Configurations of the disclosed technology address shortcomings in the prior art.

### BRIEF DESCRIPTION OF THE DRAWINGS

FIG. 1 is a perspective view of a gaming device with a position-adjustable connector, according to an example configuration.

FIG. 2 is a front view of a gaming device, such as the gaming device of FIG. 1, with an example of a mobile device to be connected to the gaming device, according to an example configuration.

FIG. 3 is a front view of the gaming device of FIG. 2 with the example mobile device connected to the gaming device.

FIG. 4 is a detail, partial cutaway view of one of the handles of the gaming device of FIG. 2.

FIG. 5 is a bottom, partial sectional view of the handle of FIG. 4, illustrating use of the gaming device with a mobile device that is relatively thick.

FIG. 6 is a bottom, partial sectional view of the handle of FIG. 4, illustrating use of the gaming device with a mobile device that is relatively thin.

FIG. 7 is a detail, partial cutaway view of one of the handles of a gaming device, such as the gaming device of FIG. 1, with an example of a mobile device to be connected to the gaming device, according to another second example configuration.

FIG. 8 is a bottom, partial sectional view of the handle of FIG. 7, illustrating use of the gaming device with a mobile device that is relatively thick.

FIG. 9 is a bottom, partial sectional view of the handle of FIG. 7, illustrating use of the gaming device with a mobile device that is relatively thin.

### DETAILED DESCRIPTION

As described herein, aspects are directed to an adjustable connector for connecting a mobile device to a handheld gaming device. In configurations, the adjustable connector moves in a defined z-axis to accommodate mobile devices of varying dimensions and varying protective case sizes. Moving the connector along the z-axis allows a user to bring the connector to the same height as an input port on their mobile device when the mobile device lays substantially flat against the handheld gaming device, as is desired for gameplay. Accordingly, the user may easily insert the connector without bending, twisting, or forcing either the connector or the port on their mobile device. This mitigates the potential for damage and enhances the user experience, as it gives the user free range to switch mobile devices or protective cases as the user chooses without limiting the user's ability to game with the handheld gaming device. Aspects are now described in more detail.

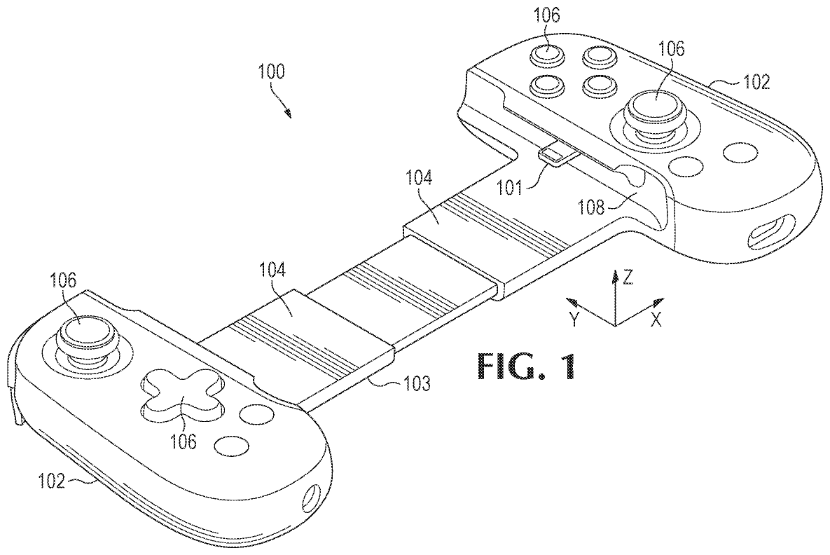

As illustrated in FIG. 1, a gaming device 100 may include an adjustable connector 101, a set of two handles 102, and a bridge 103 connecting the handles 102. In configurations, the bridge 103 may be adjustable to vary the distance between the two handles 102. As illustrated, the bridge 103 includes a platform 104 for receiving a mobile device 105, and the adjustable connector 101 extends from one of the handles 102, generally but not always the one for the user's right hand, in the direction of the bridge 103. The adjustable connector 101 is positioned to be inserted into a user's mobile device 105 when the mobile device 105 is laid substantially flat against the platform 104 with an input port 107 of the mobile device 105 facing the adjustable connector 101. In configurations, the platform 104 may be magnetic to attract the mobile device 105 to the platform 104. Each handle 102 in the illustrated configuration includes user-accessible, hardware interfaces 106, such as one or more of a button, an analog stick, a touchscreen, a touchpad, a knob, a slider, a switch, a wheel, a dial, a directional pad, or another such feature configured to accept touch inputs from a user's finger or a stylus. The gaming device 100 may be, for example, the game controller for a mobile device 105 as disclosed in U.S. Pat. No. 11,389,721. As used in this disclosure, “mobile device 105” refers to a portable, handheld computing device, such as a smartphone, tablet, or other comparable mobile device 105.

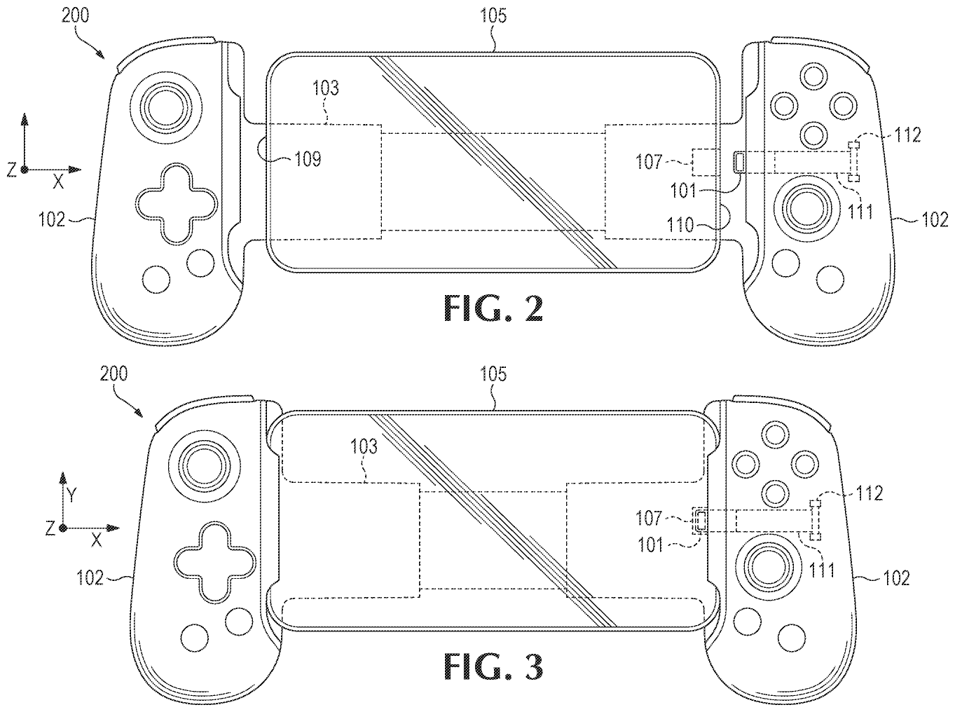

For the purposes of explaining features within this disclosure, a three-dimensional axis system is defined. As shown in the drawings, the x-axis is the direction that is substantially parallel to the longitudinal axis of the bridge 103; the y-axis is the direction substantially parallel to the contact surfaces 108 of the handles 102; and the z-axis is the direction in and out of the plane of FIGS. 2 and 3. As used in this context, “substantially parallel” means largely or essentially equidistant at all points, without requiring perfect parallelism. The contact surfaces 108 of the handles 102 are where the left edge 109 and right edge 110 of the mobile device 105 (in landscape position) contact the handles 102 when the mobile device 105 is installed in the gaming device 100, such as shown in FIG. 3. The z-axis, then, is generally toward or away from the user's face during typical use of the gaming device 100. The adjustable connector 101 is structured to move along the z-axis. Accordingly, when a user inserts the mobile device 105, the adjustable connector 101 may be moved up or down along the z-axis to meet the input port 107 of the mobile device 105 at its location on the z-axis. Preferably, the adjustable connector 101 is constrained to travel no more than four millimeters on the z-axis, making the maximum linear displacement of the adjustable connector 101 in the z-axis four millimeters. More preferably, the adjustable connector 101 is constrained to travel no more than three millimeters on the z-axis. Even more preferably, the adjustable connector 101 is constrained to travel no more than two millimeters on the z-axis.

This motion of the adjustable connector 101 along the z-axis occurs while substantially restricting motion in either the x-direction or y-direction. As used in this disclosure “substantially restricting” means largely or essentially hindering, without requiring perfect avoidance of all occurrences. In other words, the adjustable connector 101 may move up and down along the z-axis without twisting, bending, pushing, pulling, or otherwise shifting in other directions. Hence, motion of the adjustable connector 101 is constrained to the z-axis. As a result, the adjustable connector 101 allows for secure connection with mobile devices 105 of varying sizes.

To allow movement along the z-axis, the adjustable connector 101 illustrated in FIGS. 2-6 is structured as a cantilever. The gaming device 200 of FIGS. 2-6 may have the features of those discussed above for the gaming device 100 FIG. 1 in addition to those noted here.

In configurations, the adjustable connector 101 is attached to a substantially rigid arm 111. As used in this disclosure, “substantially rigid” means largely or essentially stiff and not pliant, without requiring perfect inflexibility. In configurations, the arm 111 may be made of metal, hard plastic, or any other substantially rigid material suitable for resisting movement in unwanted directions. As illustrated, the arm 111 is positioned inside a handle 102 of the gaming device 200. The adjustable connector 101 is coupled to one end of the arm 111, and the arm 111 is coupled to the handle 102 at the opposite end with a pivot 112. Accordingly, the adjustable connector 101 is configured to rotate about the pivot 112 with the arm 111, resulting in motion in the z-axis of the adjustable connector 101. Because of the pivoting motion, there may be some motion of the adjustable connector 101 in the x-axis as well as in the z-axis, but the motion in the z-axis is preferably at least five times greater than the motion of the adjustable connector 101 in the x-axis, which is accomplished in some configurations by having the pivot 112 be at least a minimum distance away from the adjustable connector 101.

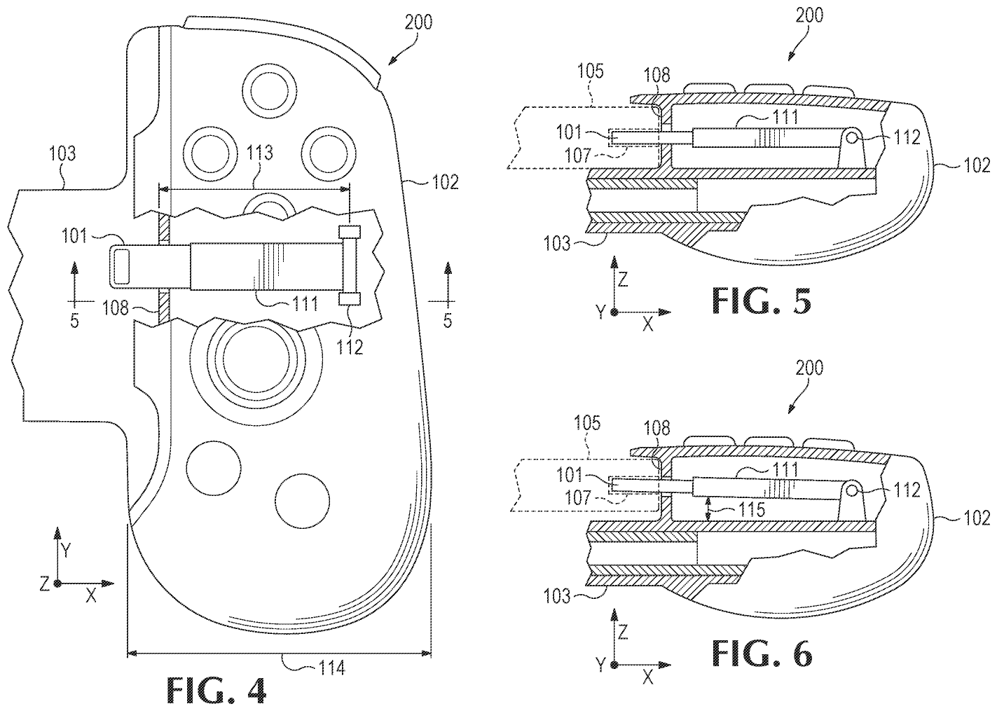

As illustrated, the adjustable connector 101 extends from the contact surface 108 of the handle 102 in the x-direction. Movement of the adjustable connector 101 is constrained to be in the z-direction and to an amount not to exceed a maximum linear displacement, such as discussed above. Preferably, the pivot 112 is at least a distance equivalent to three times the maximum linear displacement away from the contact surface 108 so that movement of the adjustable connector 101 in the z-axis is substantially greater than movement of the adjustable connector 101 in the x-axis when the adjustable connector 101 rotates about the pivot 112 with the arm 111. Hence, if the maximum linear displacement of the adjustable connector 101 in the z-axis is three millimeters, the pivot 112 is preferably not less than fifteen millimeters away from the contact surface 108. The distance between the pivot 112 and the contact surface 108 is shown as the pivot distance 113 in FIG. 4. More preferably, the pivot 112 is at least a distance equivalent to five times the maximum linear displacement away from the contact surface 108. Even more preferably, the pivot 112 is at least a distance equivalent to ten times the maximum linear displacement away from the contact surface 108.

The handle 102 has a width 114 measured from the contact surface 108 in the x-axis. Preferably, the pivot 112 is located a distance of at least one-quarter the width 114 of the handle 102 away from the contact surface 108 so that movement of the adjustable connector 101 in the z-axis is substantially greater than movement of the adjustable connector 101 in the x-axis when the adjustable connector 101 rotates about the pivot 112 with the arm 111. More preferably, the pivot 112 is located a distance of at least half the width 114 of the handle 102 away from the contact surface 108. Even more preferably, the pivot 112 is located a distance of at least three-quarters the width 114 of the handle 102 away from the contact surface 108.

What is common for the two configurations just discussed is that the length of the arm 111 is significantly longer than the maximum linear displacement along the z-axis. Accordingly, only a minimal sweep angle 115 is required to complete the required displacement, making the component of displacement along the x-axis nearly imperceptible to the user. Preferably, the sweep angle 115 is less than about twenty degrees. More preferably, the sweep angle 115 is less than about ten degrees. Even more preferably, the sweep angle 115 is less than about five degrees. Hence sweep angle 115 does not significantly impact the entry angle of the adjustable connector 101 when it is inserted into the input port 107. In this way, configurations of the disclosure improve upon existing devices, such as docking stations, that utilize a hinge point much closer to a connector and largely vary the approach angle of the connector. In addition, for the two configurations just discussed the distance that the adjustable connector 101 extends from the contact surface 108 of the handle 102 in the x-direction does not significantly change; so any slight movement in the x-direction does not affect the fit of the mobile device 105 on the adjustable connector 101.

In configurations, the adjustable connector 101 may be biased to one extent or the other of its maximum linear displacement. For example, the adjustable connector 101 may be biased as far toward the bridge 103 as it is constrained to travel (i.e. all the way “down” in the z-axis relative to the view of FIGS. 5 and 6). As another example, the adjustable connector 101 may be biased as far away from the bridge 103 as it is constrained to travel (i.e. all the way “up” in the z-axis relative to the view of FIGS. 5 and 6). In such configurations, the adjustable connector 101 returns to its biased position when it is not connected to the input port 107 of the mobile device 105 or otherwise acted on by an outside force. The biasing may be accomplished by a spring mechanism, for example. Preferably, the adjustable connector 101 is biased all the way “up” in the z-axis. This biasing all the way “up” helps to ensure that relatively thin mobile devices 105 that do not have cases are pushed up and there is minimum difference between the surface of the screen of the mobile device 105 and the play surfaces where the input buttons (i.e. the user-accessible, hardware interfaces 106) are located. Accordingly, the screen of a relatively thin mobile device 105 of the type just noted (i.e. the thinnest expected scenario) would sit at about the same height as a screen of a relatively thick mobile device 105 having a case (i.e. the thickest expected scenario) when each is installed in the gaming device 200.

To connect a mobile device 105 to the gaming device 200 using the cantilever mechanism, such as depicted in FIGS. 2-6, the user lays the mobile device 105 flat against the platform 104. The user then brings the adjustable connector 101 up to the necessary height along the z-axis to be inserted into the input port 107. To the user, this motion is perceived as vertically lifting the adjustable connector 101, despite the user actually rotating the adjustable connector 101 about the pivot 112 within the handle 102. Because the rotational motion is imperceptible, the adjustable connector 101 remains relatively flat in the x-y plane of the gaming device 200 and thus connects with the input port 107 without bending within the input port 107. To disconnect the mobile device 105, the user simply pulls the adjustable connector 101 out of the input port 107. The mobile device 105 is then free to be removed from the platform 104 and taken out of the gaming device 200.

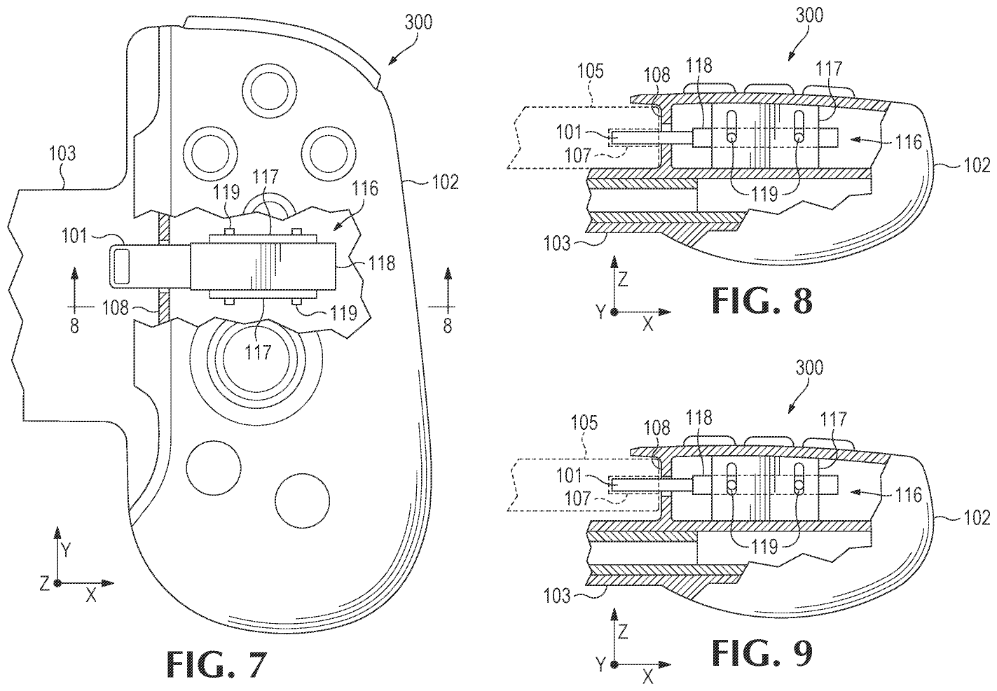

Configurations of the disclosure may implement what is referred to here as an elevator mechanism 116 rather than a cantilever. The gaming device 300 of FIGS. 7-9 may have the features of those discussed above for the gaming device 100 FIG. 1 in addition to those noted here.

As illustrated in FIGS. 7-9, in such configurations the adjustable connector 101 is coupled to a track 117, perhaps through a moveable bracket 118 that is slidably mounted in the track 117 at one or more contact points 119. The track 117 is structured to permit motion only along the z-axis. Accordingly, the moveable bracket 118, and hence the adjustable connector 101, is configured to translate in two directions along the z-axis of the track 117. The track 117 is positioned within the housing of one of the handles 102. As illustrated, the adjustable connector 101 extends from the contact surface 108 of the handle 102 in the x-direction, though the adjustable connector 101 may be mounted to the moveable bracket 118. In configurations, the moveable bracket 118 and track 117 may be made of metal, hard plastic, or any other substantially rigid material suitable for resisting movement in unwanted directions.

When connecting a mobile device 105 to the gaming device 300 having the elevator mechanism 116, a user lays the mobile device 105 flat against the platform 104 and raises the adjustable connector 101 to the necessary height on the z-axis by moving the moveable bracket 118 along the track 117. The user then inserts the adjustable connector 101 into the input port 107, and the moveable bracket 118 is maintained at its height along the z-axis. To disconnect, the user simply pulls the adjustable connector 101 from the input port 107 and removes the mobile device 105 from the platform 104.

In configurations, the track 117 may utilize high-friction materials tending to maintain the height of the moveable bracket 118 and adjustable connector 101 within the track 117 and only allow motion when force is applied. Accordingly, configurations may permit a user to maintain the adjustable connector 101 at a suitable height for the mobile device 105 for future uses, without having to readjust the adjustable connector 101 with every use of the gaming device 300. In other configurations, the adjustable connector 101 may be biased to one extent or the other of its permitted displacement. For example, the adjustable connector 101 may be biased as far toward the bridge 103 as it is constrained to travel (i.e. all the way “down” in the z-axis relative to the view of FIGS. 8 and 9). As another example, the adjustable connector 101 may be biased as far away from the bridge 103 as it is constrained to travel (i.e. all the way “up” in the z-axis relative to the view of FIGS. 8 and 9). In such configurations, the adjustable connector 101 returns to its biased position when it is not connected to the input port 107 of the mobile device 105 or otherwise acted on by an outside force. The biasing may be accomplished by a spring mechanism, for example.

Other variations of the position-adjustable connector for mobile device controller include an adjustable connector that pivots about a hinge where the adjustable connector is coupled to the contact surface of the handle. In another variation, the adjustable connector is coupled to the contact surface of the handle through a compliant material that permits movement of the adjustable connector. Both of these variations would permit mobile devices of varying thicknesses to be used with the gaming device.

An alternative to adjusting the position of the connector (as discussed above) is to change the mobile device's position. This can be achieved, for example, by adding or removing pads or other shims between the mobile device and the gaming device, thereby leveling the input port of the mobile device with the connector of the gaming device.

Configurations of the disclosure may utilize any appropriate type of data or power connector for the adjustable connector 101. Examples of the adjustable connector 101 include a Lightning male connector or a USB-C male connector.

In addition, while configurations were described in connection with a game controller, the disclosed technology is not limited in all configurations to use with game controllers. For example, the technology may be applied to docking stations for mobile devices.

### Examples

Illustrative examples of the disclosed technologies are provided below. A particular configuration of the technologies may include one or more, and any combination of, the examples described below.
Example 1 includes a gaming device, comprising: a handheld controller with a handle; and a mechanism for connecting the handheld controller to a mobile device, comprising: a substantially rigid arm housed within the handle and configured to pivot about a pivot point within the handle, and a connector attached to the arm at the end opposite the pivot point and structured to physically and electrically pair the mobile device and the handheld controller, the connector structured to pivot about the pivot point with the arm.
Example 2 includes the gaming device of Example 1, in which the connector extends from a contact surface of the handle, in which the handle has a width in an x-direction measured from the contact surface, and in which the pivot point is located at least one-quarter the width of the handle away from the contact surface.
Example 3 includes the gaming device of Example 2, in which the pivot point is located at least half the width of the handle away from the contact surface.
Example 4 includes the gaming device of Example 2, in which the pivot point is located at least three-quarters the width of the handle away from the contact surface.
Example 5 includes the gaming device of any of Examples 1-4, in which the connector extends from a contact surface of the handle, and in which the connector is constrained to travel not more than a maximum linear displacement, in which the pivot point is located away from the contact surface at a distance not less than three times the maximum linear displacement.
Example 6 includes the gaming device of Example 5, in which the pivot point is located away from the contact surface at a distance not less than five times the maximum linear displacement.
Example 7 includes the gaming device of Example 5, in which the pivot point is located away from the contact surface at a distance not less than ten times the maximum linear displacement.
Example 8 includes the gaming device of any of Examples 1-7, in which the connector is constrained to travel no more than three millimeters when pivoting about the pivot point with the arm.
Example 9 includes the gaming device of any of Examples 1-8, in which the handle is a first handle, the handheld controller further comprising: a second handle; and a bridge connecting the first handle and the second handle.
Example 10 includes a gaming device, comprising: a handheld controller, structured to connect with a mobile device; a track within a handle of the handheld controller; and a connector for physically and electrically pairing the mobile device and gaming device, the connector being coupled to the track and configured to translate along an axis of the track in a first direction and in a second direction, the second direction being opposite the first direction.
Example 11 includes the gaming device of Example 10, further comprising a bracket slidably mounted to the track and configured to translate in the first direction and in the second direction along the axis of the track, in which the connector is coupled to the track through the bracket.
Example 12 includes the gaming device of any of Examples 10-11, in which the connector extends from a contact surface of the handle.
Example 13 includes the gaming device of any of Examples 10-12, further comprising a spring mechanism to bias the connector in the first direction.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the device may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

1. A gaming device, comprising:
a handheld controller with a handle; and
a mechanism for connecting the handheld controller to a mobile device, comprising:
a substantially rigid arm housed within the handle and configured to pivot about a pivot point within the handle, and
a connector attached to the arm at the end opposite the pivot point and structured to physically and electrically pair the mobile device and the handheld controller, the connector structured to pivot about the pivot point with the arm.

2. The gaming device of claim 1, in which the connector extends from a contact surface of the handle, in which the handle has a width in an x-direction measured from the contact surface, and in which the pivot point is located at least one-quarter the width of the handle away from the contact surface.

3. The gaming device of claim 2, in which the pivot point is located at least half the width of the handle away from the contact surface.

4. The gaming device of claim 2, in which the pivot point is located at least three-quarters the width of the handle away from the contact surface.

5. The gaming device of claim 1, in which the connector extends from a contact surface of the handle, and in which the connector is constrained to travel not more than a maximum linear displacement, in which the pivot point is located away from the contact surface at a distance not less than three times the maximum linear displacement.

6. The gaming device of claim 5, in which the pivot point is located away from the contact surface at a distance not less than five times the maximum linear displacement.

7. The gaming device of claim 5, in which the pivot point is located away from the contact surface at a distance not less than ten times the maximum linear displacement.

8. The gaming device of claim 1, in which the connector is constrained to travel no more than three millimeters when pivoting about the pivot point with the arm.

9. The gaming device of claim 1, in which the handle is a first handle, the handheld controller further comprising:
a second handle; and
a bridge connecting the first handle and the second handle.

10. A gaming device, comprising:
a handheld controller, structured to connect with a mobile device;
a track within a handle of the handheld controller; and
a connector for physically and electrically pairing the mobile device and gaming device, the connector being coupled to the track and configured to translate along an axis of the track in a first direction and in a second direction, the second direction being opposite the first direction.

11. The gaming device of claim 10, further comprising a bracket slidably mounted to the track and configured to translate in the first direction and in the second direction along the axis of the track, in which the connector is coupled to the track through the bracket.

12. The gaming device of claim 10, in which the connector extends from a contact surface of the handle.

13. The gaming device of claim 10, further comprising a spring mechanism to bias the connector in the first direction.

14. A game controller comprising:
a handle;
a substantially-rigid arm housed within the handle and configured to pivot about a pivot point within the handle, and
a connector attached to the substantially-rigid arm at an end opposite the pivot point and structured to physically and electrically connect with a mobile device, wherein the connector is further structured to pivot about the pivot point with the substantially-rigid arm.

15. The game controller of claim 14, wherein:
the connector extends from a contact surface of the handle;
the handle has a width in an x-direction measured from the contact surface; and
the pivot point is located at least one-quarter the width of the handle away from the contact surface.

16. The game controller of claim 15, wherein the pivot point is located at least half the width of the handle away from the contact surface.

17. The game controller of claim 15, wherein the pivot point is located at least three-quarters the width of the handle away from the contact surface.

18. The game controller of claim 14, wherein:
the connector extends from a contact surface of the handle;
the connector is constrained to travel not more than a maximum linear displacement; and
the pivot point is located away from the contact surface at a distance not less than three times the maximum linear displacement.

19. The game controller of claim 14, wherein the connector is constrained to travel no more than three millimeters when pivoting about the pivot point with the arm.

20. The game controller of claim 15, wherein the handle comprises a first handle, and wherein the game controller further comprises:
a second handle; and
a bridge connecting the first handle and the second handle.
